(19) United States
(12) Patent Application Publication
(10) Pub. No.: US 2008/0204992 A1
(43) Pub. Date: Aug. 28, 2008

(54) Data storage system including recessed USB port

(75) Inventors: Steven C. Swenson, Champlin, MN (US); Yung Yip, Afton, MN (US)

Correspondence Address: Eric D. Levinson;Imation Corp., Legal Affairs, P.O. Box 64898, St. Paul, MN, 55164-0898, US

(73) Assignee: Imation Corp.

(21) Appl. No.: 11/712,031

(22) Filed: Feb. 27, 2007

(51) Int. Cl. G06F 1/16

(52) U.S. Cl. 361/684

(57) ABSTRACT

A data storage system includes a computer and a USB device insertable into the computer. The computer includes a housing having an exterior surface that defines a recessed USB port. The recessed USB port includes an internal wall separated from the exterior surface, a USB receptacle formed in the internal wall, and a well extending between the internal wall and the exterior surface of the housing. The USB receptacle is in electrical communication with the central processing unit. The USB device includes a case defining a first end and an opposing second end and a USB connector extending from the first end of the case. In this regard, the well of the recessed USB port is configured to receive substantially an entirety of the case of an inserted USB device such that the second end of the case is substantially coplanar with the exterior surface of the housing.

### THE FIELD OF THE INVENTION

Aspects relate to a data storage system including USB devices insertable into a computer and, more particularly, to recessed USB ports formed in a housing of the computer that improve portability of the system by configuring the computer to enclose substantially an entirety of a case of an inserted USB device.

### BACKGROUND

Universal serial bus (USB) devices have gained wide acceptance from users of electronic devices. USB devices have no moving parts that could potentially fail and cause data loss, and so are ideal for providing portable memory storage.

Most USB devices have solid-state, non-volatile, rewritable memory that has attributes of random access memory (RAM) and hard disk drive memory. The memory is a permanent memory that stores bits of data electronically in memory cells, similar to dynamic random access memory (DRAM), but it also has attributes of a hard disk drive in that when the power is turned off, the data remains in memory. Because of its high speed, durability, and low voltage requirements, the memory in a USB device is ideal for use with a variety of electronics, such as computers, including laptop computers, digital cameras, cell phones, printers, handheld computers, pagers, and audio recorders.

USB devices have connectors that are insertable into a USB receptacle of an electronic device. In this regard, all USB devices comply with the standard USB bus protocol developed by the USB Implementers Forum, Inc. The USB Standard is available at http://www.usb.org/home. There are generally two styles of USB connectors: Series A and Series B, and two styles of complementary receptacles: Series A receptacles and Series B receptacles. Series A connectors mate with only Series A receptacles, and Series B connectors mate with only Series B receptacles.

Portable electronic devices, such laptop computers, have increased in popularity because the devices permit seamless communications and data connectivity for the user in a range of environments including libraries, public transportation, in corporate meeting rooms, and college campuses. With this in mind, data collected and stored in one environment, for example data stored on a hard drive of a shared system of a college campus, can be saved to a USB device and ported elsewhere or accessed in transit by the user's personal computer.

Using USB devices in portable electronics can present some challenges. For example, although memory storage on a USB device is permanent and non-volatile, twisting or bending of a portion of an inserted USB device that projects from the electronic device is likely to damage some portion of the electronic device and/or some portion of the USB device. Thus, the risk of damaging or disconnecting the USB device from the electronic device can limit a user's desire to port/carry the device, which decreases the overall usefulness of the portable electronic device.

USB devices have proven to be a popular and convenient form of permanently storing data in a portable format. Improvements in the portability and usability of USB devices will be welcomed by users of portable electronics. For this and other reasons, there is a need for the present invention.

### SUMMARY

One embodiment provides a data storage system including a computer and a USB device insertable into the computer. The computer includes a housing enclosing a central processing unit, where the housing includes an exterior surface that defines a recessed USB port. The recessed USB port includes an internal wall separated from the exterior surface, a USB receptacle formed in the internal wall, and a well extending between the internal wall and the exterior surface of the housing. The USB receptacle is in electrical communication with the central processing unit. The USB device is insertable into the recessed USB port and includes a case defining a first end and an opposing second end and a USB connector extending from the first end of the case. In this regard, the well of the recessed USB port is configured to receive substantially an entirety of the case of an inserted USB device such that the second end of the case is substantially coplanar with the exterior surface of the housing.

Another embodiment provides a method of connecting a USB device to a USB port. The method includes providing a USB device including a case defining a first end and an opposing second end and a USB connector extending from the first end of the case, and providing a recessed USB port formed in an exterior surface of a housing of an electronic device. The method additionally includes inserting the case of the USB device into a well of the recessed USB port, and connecting the USB connector to a USB receptacle coupled to a base of the well.

Another embodiment provides a data storage system including a computer and a USB device insertable into the computer. The computer includes a housing enclosing a central processing unit, where the housing defines a recessed USB port terminating in a USB receptacle that is in electrical communication with the central processing unit. The USB device includes a case defining a first end and an opposing second end and a USB connector extending from the first end of the case. The case is insertable into the recessed USB port. In this regard, an entrance perimeter of the recessed USB port is keyed to accept a single connection orientation of the USB case.

### BRIEF DESCRIPTION OF THE DRAWINGS

The accompanying drawings are included to provide a further understanding of the present invention and are incorporated in and constitute a part of this specification. The drawings illustrate example embodiments and, together with the description, serve to explain principles of the invention. Other embodiments and many of the intended advantages of the embodiments will be readily appreciated as they become better understood by reference to the following detailed description. The elements of the drawings are not necessarily to scale relative to each other. Like reference numerals designate corresponding similar parts.

FIG. 1 is a perspective view of a data storage system including a recessed USB port according to one embodiment of the present invention;

FIG. 2 is a perspective view of a plug of a USB peripheral device insertable into the recessed USB port of FIG. 1;

FIG. 3 is a perspective view of a portable USB device insertable into the recessed USB port of FIG. 1;

FIG. 4 is a front view of the recessed USB port illustrated in FIG. 1;

FIG. 5A is a partial sectional view of a portion of a computer housing including the recessed USB port illustrated in FIG. 4;

FIG. 5B is a partial sectional view of the recessed USB port illustrated in FIG. 5A including an inserted USB memory device;

FIG. 6 is a perspective view of another data storage system including a removable card that defines a recessed USB port according to one embodiment of the present invention;

FIG. 7A is a front view of a keyed recessed USB port according to one embodiment of the present invention;

FIG. 7B is a perspective view of a USB device having a case keyed for insertion into the keyed recessed USB port illustrated in FIG. 7A;

FIG. 8A is a front view of another keyed recessed USB port according to one embodiment of the present invention;

FIG. 8B is a perspective view of a USB device having a case keyed for insertion into the keyed recessed USB port illustrated in FIG. 8A; and

FIG. 9 is a perspective view of a removable card that defines a keyed and recessed USB port according to one embodiment of the present invention.

### DETAILED DESCRIPTION

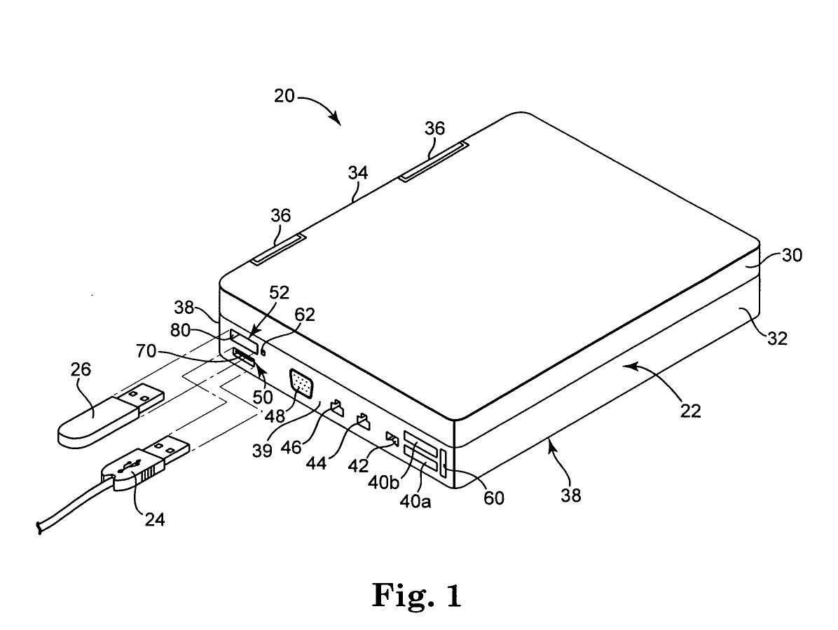

FIG. 1 illustrates a perspective view of a data storage system 20 according to one embodiment of the present invention. The system 20 includes a portable electronic device in the form of a computer 22, and USB devices 24 and 26 that are insertable into the computer 22.

The computer 22 is akin to a laptop computer and includes a monitor portion 30 hinged to a housing 32 along a back side 34, for example, by hinges 36 that permit the monitor portion 30 to be opened in clamshell-fashion relative to the housing 32. Other portable electronic devices other than laptop computers, such as handheld devices, are also acceptable and within the scope of this application.

In general, the housing 32 forms an enclosure 38 defining an exterior surface 39, where the enclosure 38 maintains a central processing unit (CPU) and includes multiple ports that electrically communicate with the CPU. For example, in one embodiment housing 32 includes a pair of replaceable card ports 40a and 40b, a peripheral port 42, a network port 44, a phone port 46, a pin port 48, a standard USB port 50, and a recessed USB port 52. An ejection mechanism 60 is provided to sequentially eject card ports 40a and 40b, and a similar ejection mechanism 62 is provided to eject USB device 26 when it is inserted into and engulfed by recessed USB port 52.

Card ports 40a and 40b are provided to enable a user of the data storage system 20 to selectively insert data cards into computer 22 to increase memory of computer 22 or customize connectivity of computer 22. Generally, card ports 40a and 40b are occupied by either an electronic card or a dummy plastic card that are removable via ejection mechanism 60. Ejection mechanism 60 is mounted flush to the housing 32 and defines a button that is configured to be pushed into housing 32 and spring-biased out of housing 32 to an ejection position. In the ejection position, a subsequent push of ejection mechanism 60 ejects the card occupying card port 40a. Pushing ejection mechanism 60 a third time will eject the card occupying card port 40b. In this manner, ejection mechanism 60 is operable to remove flush-mounted cards that are inserted into card ports 40a and 40b.

Peripheral port 42, network port 44, phone port 46, and pin port 48 are provided to enable computer 22 to be connected to network systems and/or peripheral devices such as cameras, network systems, and dial-up modems. Each of the ports 40a, 40b, 42, 44, 46, and 48 is electrically connected to the CPU of the computer 22.

USB port 50 is a standard USB port including a tongue 70 and contacts (not shown) formed on tongue 70 that are electrically connected with host controller device registers within housing 32. The standard USB port 50 complies with the USB specification promulgated by the USB Implementers Forum, Inc. Either of the devices 24 or 26 is suited for insertion into the standard USB port 50.

Recessed USB port 52 defines a well 80 formed in the exterior surface 39 of the housing 32. In one embodiment, recessed USB port 52 is fabricated into the housing 32 by a manufacturer and the well 80 is recessed relative to the exterior surface 39 by a depth that is suited to entirely receive the USB device 26 connected with the computer 22. In contrast to the standard USB device 50, recessed USB device 52 is configured to engulf substantially an entirety of the USB device 26 to minimize the risk that the USB device 26 will be sheared from the housing 32 during transportation/use. However, since each device 24, 26 includes a standard connector (described below), either of the devices 24 or 26 is suited for flush-mounted insertion into the recessed USB port 52. Embodiments of the invention provide for ejection mechanism 62 (functionally similar to ejection mechanism 60) that is configured to eject an inserted USB device from the well 80.

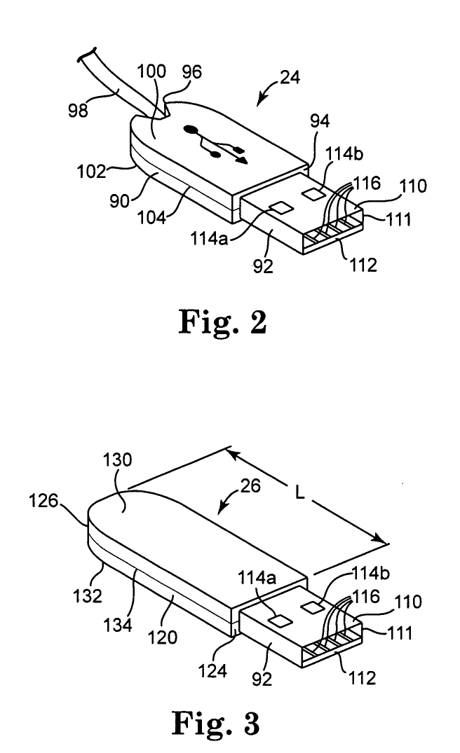

FIG. 2 is a perspective view of the USB device 24. The USB device 24 is suited for coupling a peripheral device, such as a computer mouse, to computer 22 (FIG. 1) and includes a case 90 and a connector 92 extending from the case 90. The case 90 defines a first end 94 and a second end 96 separated from the first end 94. The connector 92 extends from the first end 94, and a cable 98 extends from the second end 96, where the cable 98 is coupled to some sort of peripheral device, such as the computer mouse.

In one embodiment, the case 90 includes a first case section 100 and a second case section 102 that combine to surround a printed circuit board (not shown) and a portion of the connector 92 that extends from the first end 94. In one embodiment, the first and second case sections 100, 102 are molded from a polymer and welded along a part line 104 of the case 90. In general terms, the standard USB connector 92 defines a symmetric rectangular perimeter in compliance with the USB standards. Since the case 90 is molded about the connector 92, the first end 94 of the case 90 likewise defines a generally rectangular perimeter.

The connector 92 complies with USB standards for connectors and includes a protective metal sheath 110 that defines a leading end 111, where the sheath 110 is disposed around a tongue 112 that terminates adjacent to the leading end 111 of the sheath 110. In one embodiment, the sheath 110 defines retention windows 114a, 114b that are configured to couple with the standard USB port 50 (FIG. 1) to hold the inserted connector 92 in the port 50. The tongue 112 is a polymeric protector disposed within the sheath 110 and includes multiple contacts 116 formed on an upper surface. The contacts 116 are configured to mate with similar contacts formed on a lower surface of a receptacle of the standard USB port 50 (FIG. 1). In this regard, the case 90 and the connector 92 combine to form a “plug” of a standard USB peripheral device.

In one embodiment, the cable 98 is a twisted wire cable that extends from the second end 96 of the case 90 and is connected to a peripheral device such as a computer mouse, a keyboard, a game pad, a joystick, a scanner, a camera, a printer, or a network component, to name several.

FIG. 3 is a perspective view of the USB device 26. The USB device 26 is a portable device, such as a flash memory stick, characterized by the absence of a peripheral cable. The portable USB device 26 includes a case 120 and the USB standard connector 92 extending from the case 120.

The case 120 defines a case length L extending between a first end 124 and a second end 126, where the USB standard connector 92 extends from the first end 124 of the case 120. In one embodiment, the case 120 includes a first case section 130 and a second case section 132 that combine along a part line 134 to surround a printed circuit board (not shown) and a portion of the connector 92 that extends from the first end 124 of the case 120. The case 120 is molded from suitable polymers and can be formed to mate with a removable cap (not shown) of the USB device 26. In general terms, the sheath 110 of the standard USB connector 92 defines a rectangular perimeter in compliance with the USB standards. Since the case 120 is molded about the connector 92, the first end 124 of the case 120 defines a generally rectangular perimeter.

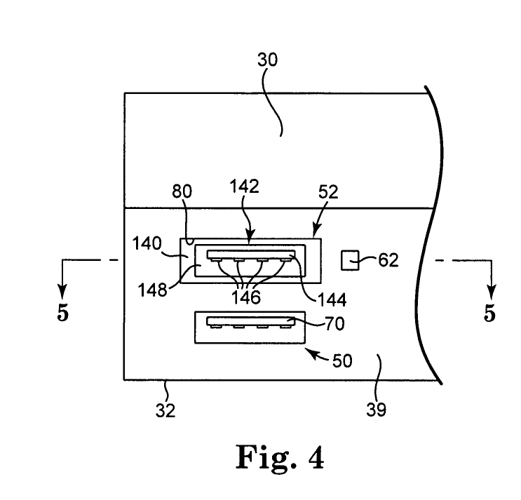

FIG. 4 is a front view of the recessed USB port 52 formed in the housing 32. The well 80 is recessed relative to the exterior surface 39 of the housing 32 and extends inward from the exterior surface 39 to a wall 140. A USB receptacle 142 is recessed into the wall 140 and includes a receptacle tab 144 that defines contacts 146. In one embodiment, the receptacle tab 144 extends from a base 148 of the recessed USB port 52 to the wall 140, such that the receptacle tab 144 is coplanar with the wall 140 and available for connection with the USB connector 92 (FIGS. 2 and 3).

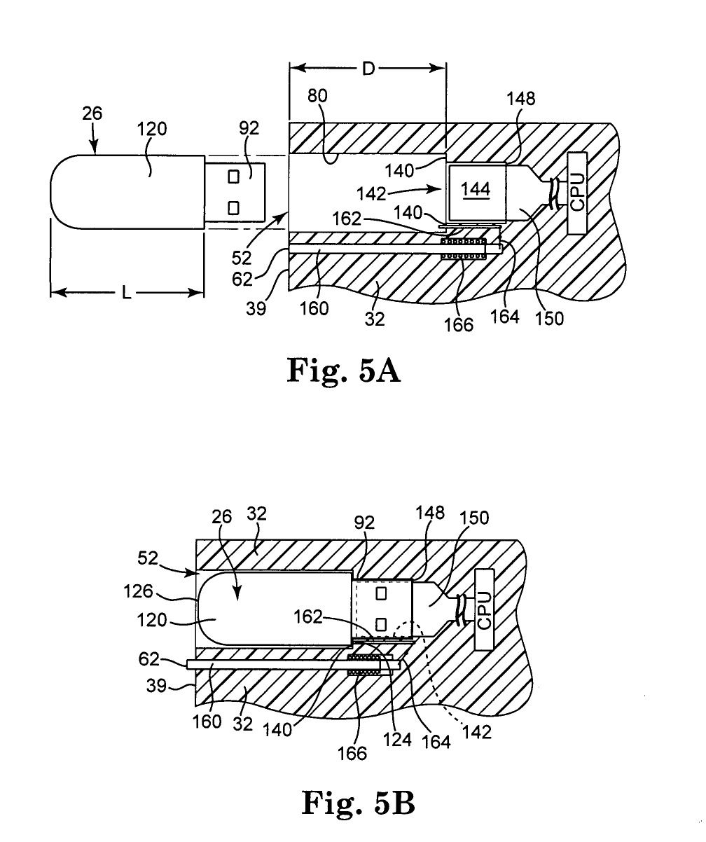

FIG. 5A is a simplified cross-sectional top view of the recessed USB port 52 taken along line 5-5 in FIG. 4. The well 80 is recessed relative to the exterior surface 39 of the housing 32 and defines a depth D extending from the exterior surface 39 to the wall 140. In one embodiment, the wall 140 is an internal wall of the housing 32 and the well 80 terminates at the internal wall 140. In this regard, the internal wall 140 is separated from the exterior surface 39, and the base 148 is separated from the internal wall 140. In one exemplary embodiment, the depth D of the well 80 is between about 2-2.5 inches, although other dimensions are also acceptable to accommodate other USB devices or electronic systems having varying electronic components.

The USB receptacle 142 extends from the base 148 and provides clearance relative to the housing 32 to enable the USB connector 92 (FIGS. 2 and 3) to slide over the USB receptacle 142. In one embodiment, an electrical strip 150 electrically couples the receptacle tab 144 to host controller device registers (not shown) inside the housing 32, and ultimately couples the receptacle tab 144 to the CPU.

In one embodiment, the well 80, the wall 140, and the base 148 are integrally molded in the housing 32 by an original manufacturer and define an “embedded” recessed USB port 52. For example, in one embodiment the well 80 and the base 148 are formed in the housing 32, and the receptacle tab 144 is coupled to the base 148 such that the contacts 146 of the receptacle tab 144 are disposed adjacent to the wall 140. The receptacle tab 144 is subsequently electrically connected (i.e., wired) to the host controller device registers (not shown) and ultimately to the CPU.

In one embodiment, the ejection mechanism 62 includes a rod 160, an ejection prong 162, a union 164 coupled between rod 160 and the prong 162. The ejection mechanism 62 includes a spring 166 configured to bias the rod 160 relative to the exterior surface 39. As illustrated in FIG. 5A, the prong 162 projects out of the wall 140 in a manner that “pushes” the USB device 26 from the recessed USB port 52. The rod 160 is substantially flush to the exterior surface 39 when the USB device 26 is ejected from the recessed USB port 52.

FIG. 5B is a simplified cross-sectional top view of the recessed USB port 52 including an inserted USB device 26. When the USB device 26 is inserted, the first end 124 of the case 120 is disposed adjacent to the wall 140, and the connector 92 seats over the USB receptacle 142. In this regard, the USB receptacle 142 is configured to receive the USB connector 92, and the well 80 is configured to receive all or substantially all of the case 120 of the USB device 26.

With reference to FIG. 5A, the depth D of the well 80 is sized to receive (or house) the case 120. In general, the depth D is at least as deep as the case 120 length L is long. In some embodiments, the depth D dimension is about the same as the length L of the case 120. Thus, when the USB device 26 is inserted, the second end 126 of the case 120 is substantially flush relative to the exterior surface 39 of the housing 32 such that any portion of the case 120 that might project from the exterior surface 39 is eliminated, thus minimizing the risk that the inserted USB device 26 will be sheared from the housing 32 when transported in the computer 22 (FIG. 1). In this configuration, the prong 162 is pressed flush against the wall 140 by the case 120, and the rod 160 is biased away from the exterior surface 39 to provide a pushbutton style of ejection mechanism 62 for the removal of the USB device 26 from the recessed USB port 52.

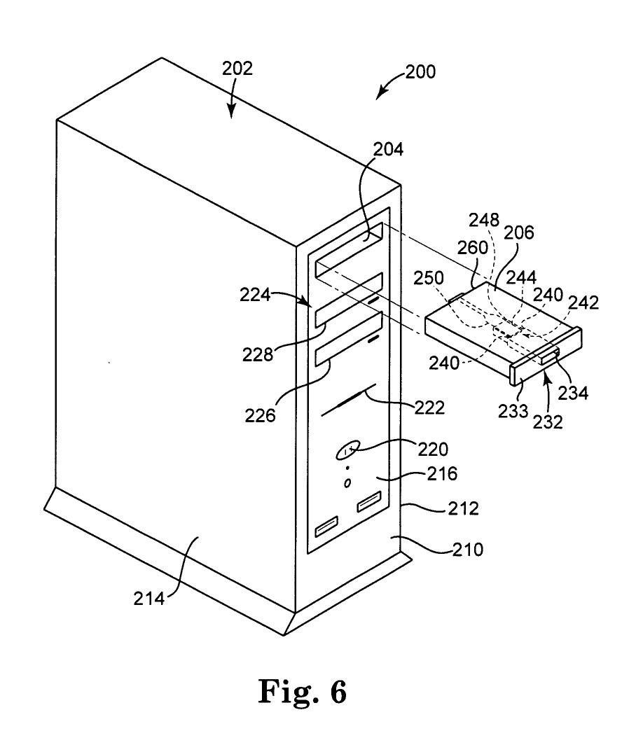

FIG. 6 is a perspective view of a data storage system 200 according to another embodiment of the present invention. The data storage system 200 includes a computer 202 having a card bay 204 and a removable module 206 that is insertable into the card bay 204. The removable module 206 provides a recessed USB port 232 that can be added as an aftermarket accessory to the computer 202.

The computer 202 is similar to desktop style computers and includes a housing 210 enclosing computer components and a CPU (not shown), opposing sides 212, 214, and a front 216. In one embodiment, the front 216 of the computer 202 provides an on/off switch 220, a floppy disk drive 222, and a plurality of drives 224 including a first drive 226 and a second drive 228. In general, the drives 226, 228 are removable drives and can include disk drives, optical disk drives, and other forms of replaceable drives. Card bay 204 is configured to receive a removable drive that can be inserted and electrically coupled to the CPU, such as module 206. Although FIG. 6 is directed to a desktop-style of computer, it is to be understood that the removable module 206 can be configured to be inserted into a drive bay of other computer architectures. For example, in one embodiment, the module 206 is insertable into an optical disk drive location of a laptop computer, such as the laptop computer 22 shown in FIG. 1.

The module 206 provides a recessed USB port 232 that is accessible via the front 216 of the computer 202 when module 206 is inserted into the computer 202. The USB port 232 recessed into the module 206 is similar to the USB port 52 (FIGS. 5A and 5B) that is recessed into the housing 32. In this regard, one embodiment of the module 206 provides an exterior surface 233 that defines a well 234 extending from the exterior surface 233 to a wall 240. A standard USB receptacle 242 is inset into the wall 240 and extends to a base 248. Electrical connectivity between the module 206 and the computer 202 is provided by an electrical strip 250 communicating with a back surface 260 of module 206.

A flexible electrical connector (not shown) within the housing 210 is configured for connection to the electrical strip 250 when the module 206 is inserted into the card bay 204. When the module 206 is so connected, a USB device (such as device 24 or 26 in FIG. 1) can be inserted into the recessed USB port 232, and electrically coupled to the USB receptacle 242 in such a manner that the case of connector 24 or 26 does not extend beyond the front 216 of the housing 210 (or the exterior surface 233 of the module 206). The module 206 thus provides one manner of modifying an existing computer 22, 202 with a removable/insertable drive that provides a recessed USB port 232. Each recessed USB port 52, 232 improves the portability of the information system by minimizing the risk that an inserted USB device will be undesirably sheared from its connection during use/transportation.

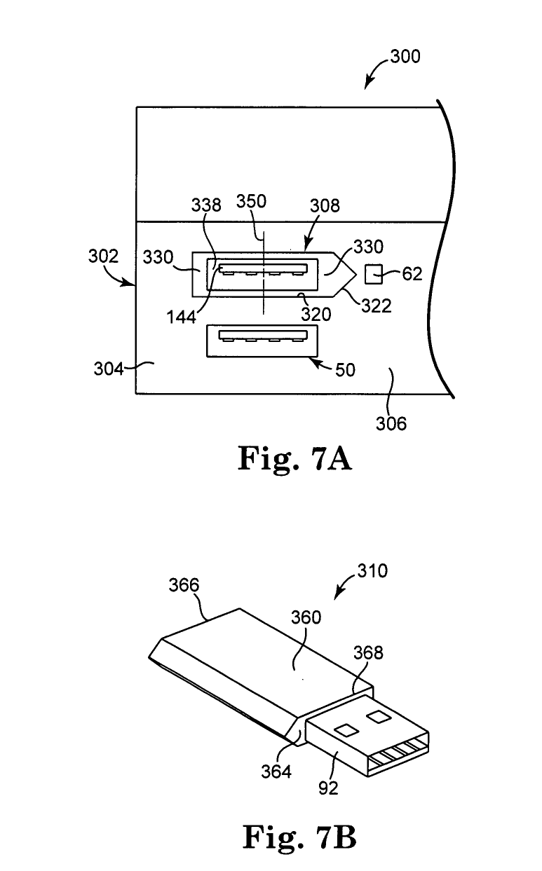

FIG. 7A is a front view of a data storage system 300 defining a keyed and recessed USB port 308, and FIG. 7B is a perspective view of a USB device 310 that is keyed for complementary insertion into the recessed USB port 308.

The data storage system 300 is similar to the data storage system 20 (FIG. 1) but additionally provides a “keyed” recessed USB port and a keyed USB device insertable into the keyed recessed USB port. This additional feature provides a visual cue to the user that enables quick and simple identification of the proper orientation for connection the USB device with the USB port. In contrast, the known USB ports are generally rectangular (as is the USB connector), resulting in some uncertainty as to which rectangular orientation of the connector will mate with the rectangular port.

System 300 includes a computer 302 having a housing 304 that defines an exterior surface 306. The recessed USB port 308 is formed in the exterior surface 306 in a manner that is similar to the recessed USB port 52 described above in FIG. 4. In one embodiment, the exterior surface 306 defines a well 320 that includes a non-rectangular perimeter 322. The well 320 is similar to the well 80 (FIG. 4) and extends from the exterior surface 306 to an interior wall 330. The USB receptacle 144 is coupled to and extends from an innermost base 338 of the recessed USB port 308 to the intermediate internal wall 330. For descriptive purposes, a vertical axis 350 is illustrated bisecting the USB receptacle 144.

In this Specification, bilateral symmetry means a lateral portion on one side of the axis 350 has a structure that is substantially similar to a lateral portion on an opposing side of the axis 350. For example, the human face is considered to be bilaterally symmetric relative to a vertical axis aligned with the nose. That is to say, bilateral symmetry is present where the structure on a left hand side of a vertical axis is similar to the structure on a right hand side of the same vertical axis.

Embodiments of the present invention provide the recessed USB port 308 having an entrance perimeter 322 that lacks bilateral symmetry relative to the axis 350. In particular, the non-rectangular perimeter 322 is characterized by an absence of bilateral symmetry relative to the axis 350 such that the right side of the recessed USB port 308 (relative to the orientation of FIG. 7A) has a structure that is different from the left side of port 308. It is to be understood that other forms of keyed and recessed USB ports having a lack of bilateral symmetry relative to a horizontal axis are also within the scope of this disclosure.

With reference to FIG. 7B, the USB device 310 includes a case 360 having a first end 364 and a second end 366 separated from the first end 364, and a standard USB connector 92 extending from the first end 364 of the case 360. In one embodiment, the case 360 defines a perimeter 368 that is congruent with the perimeter 322 of the recessed USB port 308. The perimeter 368 of the case 360 of the USB device 310 is generally non-rectangular, and since the case 360 is congruent with the port 308, the case 360 (viewed from either end 364, 366) is likewise characterized by an absence of bilateral symmetry. In one embodiment, the perimeter 368 is configured to be a mirror image of the perimeter 322 such that the well 320 is keyed to accept only a single connection orientation of the USB device 310 when it is inserted into the recessed USB port 308.

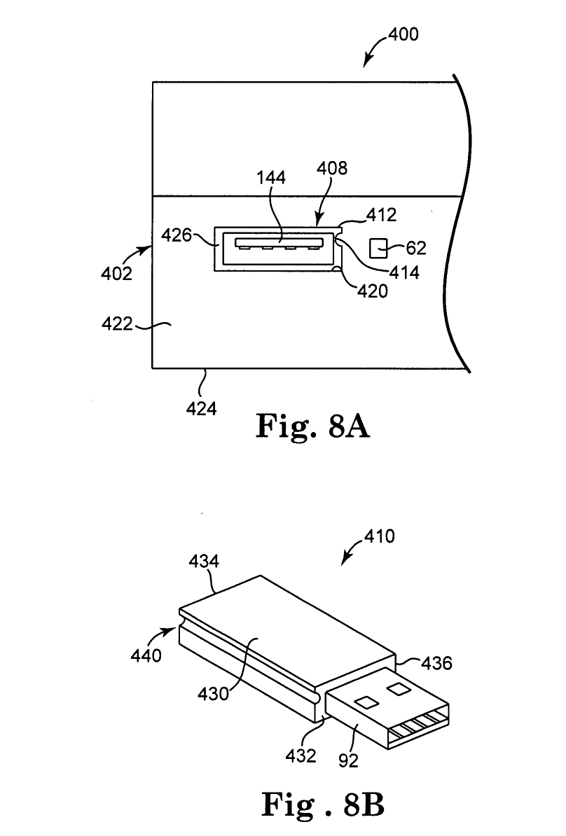

FIG. 8A is a front view of another data storage system 400 defining a keyed and recessed USB port 408, and FIG. 8B is a perspective view of a USB device 410 that is keyed for complementary connection with the recessed USB port 408. In contrast to the known USB ports, the recessed USB port 408 is configured to deny insertion of USB devices that are not specifically keyed for insertion into the recessed USB port 408. In particular, the recessed USB port 408 will not accept insertion of the typical rectangular cases of most USB devices. The USB port 408 only permits insertion and connection by USB devices keyed for port 408 (such as USB device 410). In this manner, the system 400 is suited for storing and retaining sensitive electronic information, where the USB port 408 will only connect with a suitably keyed USB device, such as device 410.

The recessed USB port 408 includes a non-rectangular entrance perimeter 412 that defines a key feature 414. The key feature 414 provides the recessed USB port 408 with a lack of bilateral symmetry. In one embodiment, a well 420 of the keyed perimeter 412 extends between an exterior surface 422 of housing 424 to an internal wall 426. The USB receptacle 144 is co-planar with the internal wall 426 and is substantially similar to the receptacles described above.

Embodiments of the present invention enable the keyed perimeter 412 of the recessed USB port 408 to deny insertion of USB devices having a rectangular perimeter (such as USB device 24 in FIG. 2 and USB device 26 in FIG. 3), and any other USB devices that are not specifically keyed for port 408.

FIG. 8B is a perspective view of USB device 410 providing a suitably keyed case 430 configured for insertion into the recessed USB port 408. The case 430 includes a first end 432, a second end 434 separated from the first end 432, and a standard USB connector 92 extending from the first end 432. In one embodiment, the case 430 includes a non-rectangular perimeter 436 that is keyed to be congruent with the perimeter 412 of the recessed USB port 408 and includes a keyed feature 440 that is complementary to the keyed feature 414 of the recessed USB port 408.

In one embodiment, the absence of bilateral symmetry of the recessed USB port 408 configures the case 430 to have only a single connection orientation relative to the recessed USB port 408. In one embodiment, the absence of bilateral symmetry of the case 430 combines with the lack of symmetry in the recessed USB port 408 such that the combination is configured to permit the case 430 to have only a single connection orientation relative to the recessed USB port 408.

In one embodiment, the cases described above are fabricated from a polymer material and formed over the connector 92. It is to be understood that the cases of the USB devices enclose printed circuitry and are preferably formed to be integral with the connector 92. In this regard, although the cases of the present invention can include part lines and mold lines, the cases are generally configured to not be opened without risking damage to the printed circuitry. Thus, destructively removing the case from the connector will destroy the functionality of the printed circuitry.

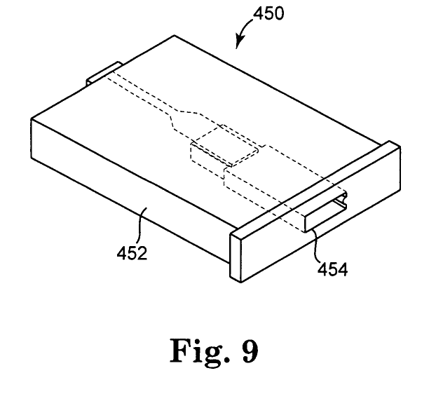

FIG. 9 is a perspective view of another data storage system 450 including a removable card 452 that defines a recessed USB port 454. In one embodiment, the recessed USB port 454 is keyed in a manner that is similar to keyed ports 308 and 408 described above. Removable card 452 provides a keyed and recessed USB port 454 that can be added as an aftermarket accessory to a computer (e.g., laptop 22 of FIG. 1 or desktop 202 of FIG. 6) having a card bay. The keyed and recessed USB port 454 enables improved portability of the computer and minimizes the risk that an inserted USB device will be undesirably sheared from the USB port.

The recessed USB ports described above protect inserted USB devices from accidental damage during use/transportation, and enable USB drives/devices to remain connected to the computer during transport. To this end, the recessed USB ports described herein enable the computer system to be optimized for use with emerging applications, such as Windows™ ReadyBoost™, and offer the system improved and portable extendible memory. In addition, certain of the embodiments described above provide a keyed recessed USB port that offers improved secure data transfer limited to specifically keyed USB devices.

Although specific embodiments have been illustrated and described herein, it will be appreciated by those of ordinary skill in the art that a variety of alternate and/or equivalent implementations may be substituted for the specific embodiments shown and described without departing from the scope of the present invention. This application is intended to cover any adaptations or variations of recessed USB ports and USB devices insertable into the recessed USB ports as discussed herein. Therefore, it is intended that this invention be limited only by the claims and the equivalents thereof.

What is claimed is:

1. A data storage system comprising:
a computer including a housing enclosing a central processing unit, the housing including an exterior surface that defines a recessed USB port including an internal wall separated from the exterior surface, a USB receptacle formed in the internal wall, and a well extending between the internal wall and the exterior surface of the housing, the USB receptacle in electrical communication with the central processing unit; and
a USB device insertable into the recessed USB port, the USB device including a case defining a first end and an opposing second end and a USB connector extending from the first end of the case;
wherein the well of the recessed USB port is configured to receive substantially an entirety of the case of an inserted USB device such that the second end of the case is substantially coplanar with the exterior surface of the housing.

2. The data storage system of claim 1, wherein the computer housing includes a removable module insertable into a card bay of the housing, the removable module including an exterior surface that defines the recessed USB port.

3. The data storage system of claim 1, wherein the recessed USB port comprises a base separated farther from the exterior surface than the internal wall, the USB receptacle extending between the base and the internal wall.

4. The data storage system of claim 3, wherein the USB receptacle comprises a receptacle tab extending from the base such that the receptacle tab is not in contact with the internal wall.

5. The data storage system of claim 1, wherein the well defines a depth extending from the exterior surface of the housing to the internal wall and the case defines a length extending between the first and second ends, the depth of the well being greater than the length of the case.

6. The data storage system of claim 1, wherein the depth of the well is about equal to the length of the case.

7. The data storage system of claim 1, wherein the well comprises a non-rectangular entrance perimeter.

8. The data storage system of claim 7, wherein a lateral cross-section of the first end of the case comprises a non-rectangular perimeter.

9. The data storage system of claim 8, wherein the non-rectangular perimeter of the case is congruent with the non-rectangular perimeter of the well.

10. The data storage system of claim 9, wherein the non-rectangular perimeter of the well is keyed to accept a single connection orientation of the non-rectangular perimeter of the case.

11. The data storage system of claim 1, wherein the first end of the case is characterized by an absence of bilateral symmetry.

12. The data storage system of claim 11, wherein the absence of bilateral symmetry configures the case to have only a single connection orientation relative to the recessed USB port.

13. The data storage system of claim 1, wherein the USB device comprises one of a portable memory device and a peripheral device including a cable extending from the second end of the case.

14. A method of connecting a USB device to a USB port, the method comprising:
providing a USB device including a case defining a first end and an opposing second end and a USB connector extending from the first end of the case;
providing a recessed USB port formed in an exterior surface of a housing of an electronic device;
inserting the case of the USB device into a well of the recessed USB port; and
connecting the USB connector to a USB receptacle coupled to a base of the well.

15. The method of claim 14, wherein inserting the case of the USB device into a well of the recessed USB port comprises inserting an entirety of the case of the USB device into a well of the recessed USB port.

16. The method of claim 15, wherein inserting an entirety of the case of the USB device into a well of the recessed USB port comprises seating the second end of the case of the USB device flush with the exterior surface of a housing of an electronic device.

17. The method of claim 14, wherein connecting the USB connector to a USB receptacle coupled to a base of the well comprises coupling the USB connector to a USB receptacle disposed at a base of the well after inserting a majority of a length of the case of the USB device into the well of the recessed USB port.

18. The method of claim 14, wherein connecting the USB connector to a USB receptacle coupled to a base of the well comprises pushing the case of the USB device past the exterior surface of the housing of an electronic device.

19. A data storage system comprising:
a computer including a housing enclosing a central processing unit, the housing including an exterior surface that defines a recessed USB port terminating in a USB receptacle that is in electrical communication with the central processing unit; and
a USB device including a case defining a first end and an opposing second end and a USB connector extending from the first end of the case, the case insertable into the recessed USB port;
wherein an entrance perimeter of the recessed USB port is keyed to accept a single connection orientation of the USB case.

20. The data storage system of claim 19, wherein the computer housing includes a removable module insertable into a card bay of the housing, the removable module including an exterior surface that defines the recessed USB port.

21. The data storage system of claim 19, wherein the entrance perimeter of the recessed USB port defines a non-rectangular shape that is congruent with a non-rectangular perimeter of the case of the USB device.

22. The data storage system of claim 19, wherein the recessed USB port is configured to receive substantially an entirety of the case of an inserted USB device such that the second end of the case is substantially coplanar with the exterior surface of the housing.
